(19) United States
(12) Patent Application Publication
(10) Pub. No.: US 2023/0090400 A1
(43) Pub. Date: Mar. 23, 2023

(54) ENERGY STORAGE DEVICE WITH OPERANDO MONITORING

(71) Applicant: Honda Motor Co., Ltd., Tokyo (JP)

(72) Inventor: Avetik HARUTYUNYAN, Santa Clara, CA (US)

(21) Appl. No.: 17/479,953

(22) Filed: Sep. 20, 2021

(51) Int. Cl. H01M 10/48; H01M 10/44; H01M 10/0525

(52) U.S. Cl. CPC H01M 10/48; H01M 10/44; H01M 10/0525; H01M 2004/028

(57) ABSTRACT

The present disclosure generally relates to apparatus and processes for monitoring the structural health of an energy storage device, and more specifically to energy storage devices with operando monitoring and processes of use. In an aspect, an apparatus is provided that includes an energy storage device comprising an electrode, the electrode comprising a nanotube network and an active material. The apparatus further includes a processor configured to determine a first value of potential change of the electrode of the energy storage device and to compare the first value of potential change to a threshold value or range.

### FIELD

The present disclosure generally relates to apparatus and processes for monitoring the structural health of an energy storage device, and more specifically to energy storage devices with operando monitoring and processes of use.

### BACKGROUND

Recent advances in electric vehicle technologies, flexible electronics, smart wearable devices, and internet of things (IoT) devices have boosted demand for energy storage devices such as batteries. With this increased demand came concerns around the environmental impact, safety, and sustainability of energy storage devices. Increasing battery lifetime and the manufacture of more structurally resilient energy storage devices would help assuage these concerns.

Therefore, there is a need for apparatus and processes for monitoring the structural health of energy storage devices.

### SUMMARY

The present disclosure generally relates to apparatus and processes for monitoring the structural health of an energy storage device, and more specifically to energy storage devices with operando monitoring and processes of use.

In an aspect, an apparatus is provided. The apparatus includes an energy storage device comprising an electrode, the electrode comprising a nanotube network and an active material, the active material comprising: LiFePO₄, LiCoO₂, Li—Ni—Mn—Co—O, or combinations thereof, when the electrode is a cathode; or Si, SiOx/C, graphite, or combinations thereof, when the electrode is an anode. The apparatus further includes a processor configured to determine a first value of potential change of the electrode of the energy storage device and to compare the first value of potential change to a threshold value or range.

In another aspect, a process for monitoring structural health of an energy storage device is provided. The process includes determining a first value of potential change of an electrode of the energy storage device, the electrode having a nanotube network and an active material embedded therein, the active material comprising: LiFePO₄, LiCoO₂, Li—Ni—Mn—Co—O, or combinations thereof, when the electrode is a cathode; or Si, SiOx/C, graphite, or combinations thereof, when the electrode is an anode. The process further includes comparing the first value of potential change to a threshold value or range.

In another aspect, a non-transitory computer-readable medium storing instructions that, when executed on a processor, perform operations for monitoring structural health of a lithium ion battery. The operations include determining a first value of potential change of an electrode of the lithium ion battery, the electrode having a nanotube network and an active material embedded therein, the active material comprising LiFePO₄, LiCoO₂, Li—Ni—Mn—Co—O, or combinations thereof, when the electrode is a cathode; or Si, SiOx/C, graphite, or combinations thereof, when the electrode is an anode. The operations further include comparing the first value of potential change to a threshold value or range.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1 is an illustration of an example energy storage device with health monitoring according to at least one aspect of the present disclosure.

FIGS. 2A, 2B, and 2C illustrate a composite electrode in two states of stress according to at least one aspect of the present disclosure.

FIG. 3 is a flowchart showing selected operations of a process for monitoring the structural health (e.g., damage) of an energy storage device according to at least one aspect of the present disclosure.

FIG. 4 is a schematic view of an example apparatus for making a self-standing electrode according to at least one aspect of the present disclosure.

FIG. 5A is an exemplary scanning electron microscopy (SEM) image of nanotubes in an example electrode according to at least one aspect of the present disclosure.

FIG. 5B is an SEM image of a composite material used in an example electrode according to at least one aspect of the present disclosure.

FIG. 5C is an exemplary photograph of an example self-standing electrode according to at least one aspect of the present disclosure.

FIG. 5D is an exemplary photograph of the example self-standing electrode shown in FIG. 5C.

FIG. 6A shows exemplary data for the normalized discharge capacity of a flexible battery according to at least one aspect of the present disclosure.

FIG. 6B shows exemplary data for the gauge factor dependence on the electrode density of the flexible battery according to at least one aspect of the present disclosure.

FIG. 6C shows exemplary data for operando measurement of the variation of the potential across the cathode when a flexible battery is subjected to mechanical stress according to at least one aspect of the present disclosure.

FIG. 7A is an exemplary photograph showing the flexible battery being bent around a cylinder while powering a light emitting diode (LED) according to at least one aspect of the present disclosure.

FIG. 7B is an exemplary photograph for operando measurement of the potential across the cathode while the flexible battery powers an LED according to at least one aspect of the present disclosure.

FIG. 7C is an exemplary photograph of a wristband-shaped flexible battery powering a smart watch and transferring data to a smart phone according to at least one aspect of the present disclosure.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION

The present disclosure generally relates to apparatus and processes for monitoring the structural health of an energy storage device, and more specifically to energy storage devices with operando monitoring and processes of use. The inventors have found apparatus and processes for in operando monitoring and/or in situ monitoring of the structural health of an energy storage device, e.g., a battery or capacitor, and/or components thereof such as an electrode. Briefly, and in some examples, the structure to be monitored, e.g., an electrode, includes a nanotube network and an active material. The active material can be in the form of a powder, e.g., an active material powder. The nanotube network, as part of the structure to be monitored, can be capable of stress, strain, bending, or otherwise deforming in response to a stimulus, thereby indicating that, e.g., damage or other change in the electrode has formed. These mechanical changes in the nanotube network also change the electrical properties of the nanotube network, such as electrical resistivity, known as a piezoresistive effect. Such electrical properties can be monitored as described herein in order to, e.g., monitor the structural health of an electrode.

Monitoring the structural health of energy storage devices and components thereof (e.g., electrodes), which are subject to fatigue, stress-strain, and corrosion, is valuable in many industries in order to reduce operating costs while maintaining high standards of safety. Detecting structural damage as it forms during the operational life of energy storage devices and electrodes can be difficult, however, particularly when the damage is under a surface. In addition, the lack in ability to monitor damage real-time leaves the energy storage devices and electrodes, as well as neighboring (physically or electrically) structures, subject to extensive damage. Embodiments described herein solve these and other problems by, e.g., exploiting electromechanical properties of nanotube networks embedded within one or more electrodes of the energy storage device. The effect of the change in electrical properties of nanotube network when exposed to a stimulus or force can assist in determining changes in the electrode during its operational life as well as changes over time due to damage to the electrode. By monitoring damage, the strain on the electrode as well as failure of the electrode can be monitored.

Certain aspects of the present disclosure can enable early detection and/or real-time detection of damage as they form in energy storage devices and electrodes. Such early and/or real-time detection enables more efficient scheduling of maintenance and repairs, and can avert problems that may go unnoticed. The detection and monitoring also provides information to engineers on how to manufacture structurally durable energy storage devices and electrodes. In addition, aspects of the present disclosure can enable detection of structural damage during the operational life of the electrode, or a component thereof, before the damage can propagate and cause damage to the electrode and/or nearby components or structures. Although certain aspects of the present disclosure are described with reference to batteries, the apparatus and processes can extend to other energy storage devices such as capacitors and supercapacitors.

In at least one aspect, and as described below, the nanotube network is embedded within an electrode to be monitored. In the absence of strain where the nanotube network has no force or stimuli acting on it, the nanotube network possess a certain electrical resistance. When the electrode to be monitored becomes damaged, the nanotube network stresses, bends, strains, or otherwise deforms. This change in the nanotube network causes the rearrangements of the nanotubes in the nanotube network by changing their alignments and contact points, and thereby causing an electrical resistance change of the electrode. The change in electrical resistance can be detected as a change in potential, or potential change, and can be indicative of the change of health (e.g., loss of health or damage) of the electrode.

For example, if a stimuli or force is applied to the electrode, and the electrode experiences damage as a result, the resistance of the nanotube network, and consequently the resistance of the electrode, will vary according to Gauge Factor to that damage rate or occurrence. Such information can be part of a baseline for understanding the routine stress that the electrode experiences. If the electrode experiences permanent damage, then the variation of resistance can also permanently change and be indicative of the health of the electrode. Damage refers to any change to the electrode material and/or geometric properties of a component (e.g., an electrode), including deformations, degradations, defects, cracks, flaws, fractures, detachments, delaminations, corrosion damage, weaknesses, and/or any other change in condition of an electrode. Such damage can be caused by a stimulus or force. Non-limiting examples of a stimulus or force can include electric, temperature, pressure, strain, stress, applied force, gravitational force, normal force, friction force, air resistance force, tension force, or spring force.

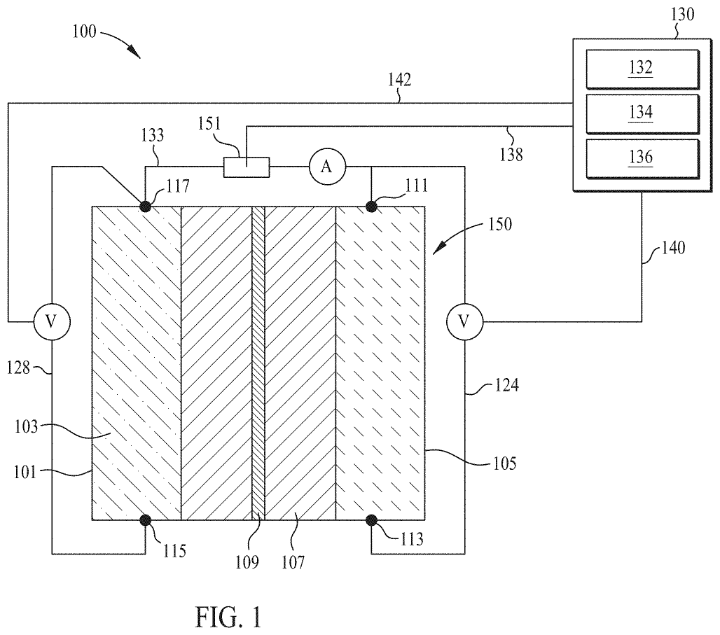

FIG. 1 is an illustration of an example energy storage device 100 with health monitoring according to at least one aspect. Monitoring of a potential or other electric characteristic along one or more electrodes (anode and cathode) can be performed, e.g., in operando and/or in situ, and any change or deviation in the potential or other electrical characteristic can indicate structural changes in the electrode.

Aspects enable monitoring of the structural health (e.g., damage) of an electrode of the energy storage device. The electrode can be part of any suitable energy storage device such as a battery (e.g. a lithium ion battery, sodium-sulfur battery, redox flow battery, fuel battery), a capacitor, or a supercapacitor (e.g. an electrochemical double layer capacitor or pseudocapacitor). In this example, the electrode to be monitored is part of a battery 150. The battery 150 includes a cathode 101, an anode 105, a separator 109 positioned between the cathode 101 and the anode 105, and an electrolyte 107. In at least one aspect, the battery 150 is, or includes, a flexible lithium metal battery and/or flexible lithium ion battery, as disclosed in U.S. patent application Ser. Nos. 16/560,731, 16/560,747, and 15/665,171, which are hereby incorporated by reference herein in their entirety. In some aspects, the electrodes are free of current collectors, binders, and/or additives as disclosed in U.S. Pat. No. 10,658,651, which is hereby incorporated by reference in its entirety. Such electrodes are, e.g., bendable, stretchable, and/or twistable. The electrodes can be self-standing electrodes for, e.g., lithium ion batteries. The electrodes, individually, can be a composite electrode.

In the illustrative, but non-limiting, embodiment of FIG. 1, the cathode 101 is the component to be monitored for damage. The cathode 101 includes a nanotube network 103. The nanotube network is made of, e.g., a plurality of nanotubes. The nanotube network 103 can be part of, or be otherwise embedded within, a composite material that forms at least a portion of the cathode 101. In this example, although only the cathode 101 includes the nanotube network 103, it is contemplated that the anode 105, or both the cathode 101 and the anode 105, can include the nanotube network 103. That is, one or both electrodes can be the component to be monitored. As discussed below the composite material that forms at least a portion of the cathode and/or anode includes a nanotube network. In some aspects, a nanotube concentration in the composite material is about 0.5 wt % or more and/or about 10 wt % or less. Higher or lower concentrations are contemplated.

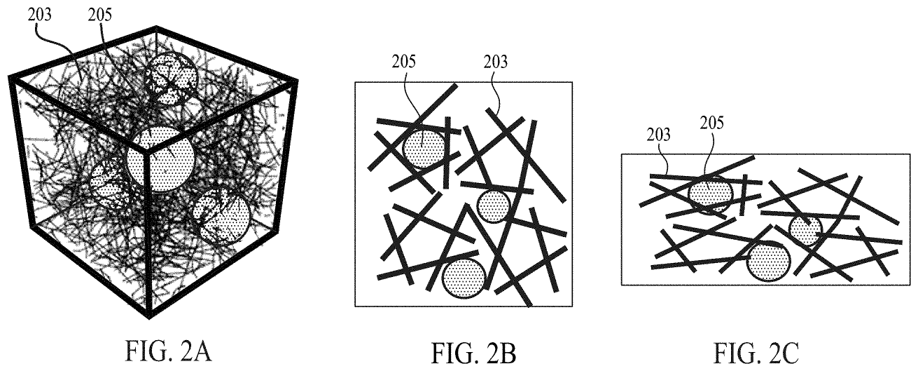

FIGS. 2A-2C illustrate a composite electrode in two states of stress. The composite electrode includes a nanotube network 203 and an active battery material 205. FIG. 2A shows a three-dimensional view of the composite electrode under no stress. FIG. 2B, which is a slice or two-dimensional view of the composite electrode of FIG. 2A, also shows the composite electrode under no stress. FIG. 2C shows a slice or two-dimensional view of the composite electrode under stress. In FIGS. 2A-2C, damage to the electrode to be monitored causes the nanotube network 203 to stress, bend, strain, or otherwise deform. As a result, the resistance of the electrode changes and such resistance can be monitored or detected, by e.g., monitoring changes in potential.

The observed piezoresistive effect is a result of, e.g., the rearrangement of the nanotube network under mechanical impact (strain). The electrode (e.g., a self-standing sheet) will change its resistance if there is formation of any damage in the electrode during battery lifetime. The insight of this network resistance change is the rearrangement of the three-dimensional microstructure of the nanotube network that leads to the sliding of nanotubes relative to each other and thereby changing the number of the contacts between them. Since the overall sheet resistance is defined by the nanotube/nanotube contact resistance, changes of the nanotube/nanotube contacts in the network lead to the sheet resistance changes. Damage is one cause that can lead to the rearrangement and thereby the resistance changes.

Referring back to FIG. 1, a first anode contact 111 and a second anode contact 113 are positioned on the anode 105, and a first cathode contact 117 and a second cathode contact 115 are positioned on the cathode. These contacts can be made of any suitable material such as Al, Cu, Ni, alloys thereof, or combinations thereof). In operation, and as an example, the first anode contact 111 and the first cathode contact 117 can be used for measurements utilizing a wire 133, while the second anode contact 113 and the second cathode contact 115 can be used to power an article 151, such as an energy consuming device, such as an automobile, a motor, consumer electronic, LED, components thereof, etc. In FIG. 1, V represents a voltmeter and A represents an ammeter. One voltmeter is on the cathode 101 side, and another voltmeter is located on the anode 105 side. A controller 130 can be electrically coupled to the article 151 via wire 138. The controller 130 can also be connected to the ammeter A by a wire (not shown), and/or one or both of voltmeters via wire 140 and/or wire 142. In some aspects, one or more of the ammeter A or voltmeter(s) V are part of the controller 130 instead of separate elements. The controller 130 can be configured to control one or more operations for monitoring the structural health of the battery 150. The first anode contact 111 and the second anode contact 113 can be electrically coupled by a wire 124, while the first cathode contact 117 and second cathode contact 115 can be electrically coupled by a wire 128.

In operation, and as further discussed below, the controller 130 can be configured to monitor, measure, and/or detect a characteristic of the energy storage device, such as a potential, a potential change, a voltage, a voltage change, a current, a current change, a resistance, and/or a resistance change. For example, the controller 130 can be configured to monitor a change in potential or potential change along the anode and/or cathode. A change in potential, such as a potential drop along the electrodes (e.g., between contacts 111 and 113 and/or contacts 115 and 117), can indicate a change in the health of battery 150 Measurements can be performed when the battery 150 is electrically connected to the article 151 or not electrically connected to the article 151. Although not shown in the device 100, equipment for noise filtering, signal amplifying, pulsing, and/or other equipment can be used with the device 100 to provide, e.g., accuracy and sensitivity for measurements and calculations.

The controller 130 includes at least one processor 132, a memory 134, and support circuits 136. The at least one processor 132 may be one of any form of general purpose microprocessor, or a general purpose central processing unit (CPU), each of which can be used in an industrial setting, such as a programmable logic controller (PLC), supervisory control and data acquisition (SCADA) systems, or other suitable industrial controller. The controller 130 can be configured to detect or sense a change in potential of the electrode (e.g., the cathode 101).

The memory 134 is non-transitory and may be one or more of readily available memory such as random access memory (RAM), read only memory (ROM), or any other form of digital storage, local or remote. The memory 134 contains instructions, that when executed by the at least one processor 132, facilitates one or more operations of processes described herein (e.g., operations of process 300). The instructions in the memory 134 are in the form of a program product such as a program that implements the method of the present disclosure. The program code of the program product may conform to any one of a number of different programming languages.

Illustrative computer-readable storage media include, but are not limited to: (i) non-writable storage media (e.g., read-only memory devices within a computer such as CD-ROM disks readable by a CD-ROM drive, flash memory, ROM chips, or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are examples of the present disclosure. In one example, the disclosure may be implemented as the program product stored on a computer-readable storage media (e.g., memory 134) for use with a computer system (not shown). The program(s) of the program product define functions of the disclosure, described herein.

Aspects described herein can be utilized with, or otherwise incorporated into, various devices utilizing energy storage devices, e.g., batteries, such as automobiles, other land vehicles (trucks), trains, aircraft, watercraft, satellite systems. In at least one aspect, the battery 150 can be electrically coupled to any suitable article 151, or one or more components of the article, that is or can be operated by an energy storage device. Illustrative, but non-limiting, examples of such articles can be a land vehicle, an aircraft, a watercraft, a spacecraft, a satellite, light emitting diode, consumer electronics (such as antennas, car radios, mobile phones, watches, and telecommunications base stations), a motor, a wind turbine, a bridge, a building, a pipeline, or components thereof.

In some aspects, the battery 150 can be permanently electrically coupled to the controller 130 as shown in FIG. 1, to enable real-time monitoring and/or monitoring continuously during operation, e.g., in operando monitoring. Additionally, or alternatively, and in at least one aspect, the battery 150 can be coupled to the controller 130 periodically, such that the electrode is monitored periodically, e.g., in situ, such as for scheduled maintenance, and/or monitored continuously during operation (e.g., in operando).

In at least one aspect, a periodic system of monitoring the structural health (e.g., damage) of an electrode over a monitored area can include data storage instead of a full data processing system. The data may include information on, damage, and if a discontinuity develops, the potential or potential change indicates that something has happened to the part. Here, the data can be retrieved periodically and processed at a maintenance depot or facility. In at least one aspect, the periodic system of monitoring can include no data collection during operation of the battery 150 (e.g., operation of a battery to power portions of an automobile during driving), and then the battery 150 can be coupled to the controller 130 at a maintenance depot or facility for data collection. For example, a maintenance connector, such as a module, can be connected to, e.g., an on-board diagnostic (OBD) port, enabling interface with a vehicle's computer system. Such a periodic system can enable collection of data off-line.

The anode 105 can include a composite material that includes anode active material (e.g., graphite, silicon, a porous material that matches or substantially matches the potential of the given cathode material, natural graphite, artificial graphite, activated carbon, carbon black, high-performance powdered graphene, etc., and combinations thereof) particles in, e.g., a three-dimensional cross-linked network of carbon nanotubes. The cathode 101 can include a composite material that includes cathode active material (e.g., lithium metal oxide, lithium metal, etc.) particles in, e.g., a three-dimensional cross-linked network of carbon nanotubes. According to some aspects, the three-dimensional cross-linked network of carbon nanotubes can have a webbed morphology, a non-woven, non-regular, or non-systematic morphology, or combinations thereof.

Metals in lithium metal oxides according to the present disclosure may include, but are not limited to, one or more alkali metals, alkaline earth metals, transition metals, aluminum, or post-transition metals, and hydrates thereof. Non-limiting examples of lithium metal oxides include lithiated oxides of Ni, Mn, Co, Al, Mg, Ti, alloys thereof, or combinations thereof. In an illustrative example, the lithium metal oxide is lithium nickel manganese cobalt oxide (LiNiₓMn_{y}Co_{z}O₂, x+y+z=1), Li(Ni,Mn,Co)O₂, or Li—Ni—Mn—Co—O. The lithium metal oxide powders can have a particle size defined within a range between about 1 nanometer (nm) and about 100 microns (μm), or any integer or subrange in between. In a non-limiting example, the lithium metal oxide particles have an average particle size of about 1 μm to about 10 μm.

In some aspects, an active material for the cathode can include LiFePO₄, LiCoO₂, Li—Ni—Mn—Co—O, or combinations thereof and/or an active material for the anode can include Si, SiOx/C, graphite, or combinations thereof.

Any suitable materials can be used for the nanotube network 103 such as carbon nanotubes. The carbon nanotubes can be doped or non-doped. The carbon nanotubes can be single-walled nanotubes, few-walled nanotubes, and/or multi-walled nanotubes. In some aspects, the carbon nanotubes are single-walled nanotubes. Single-walled carbon nanotubes can be synthesized by known methods. Few-walled nanotubes and multi-walled nanotubes may be synthesized, characterized, co-deposited, and collected using any suitable method and apparatus known, including those used for single-walled nanotubes. The carbon nanotubes may range in length from about 50 nm to about 10 cm or greater, though longer or shorter carbon nanotubes are contemplated. In some aspects, a nanotube concentration in the composite material is about 0.5 wt % or more and/or about 10 wt % or less, such as from about 0.75 wt % to about 8 wt %, such as from about 1 wt % to about 5 wt %, such as from about 2 wt % to about 4 wt %, such as from about 2.5 wt % to about 3.5 wt %. Higher or lower concentrations are contemplated.

Suitable materials useful for the separator 109 include those known to persons of ordinary skill in the art for use in between battery anodes and cathodes, to provide a barrier between the anode and the cathode while enabling the exchange of lithium ions from one side to the other, such as a membranous barrier or a separator membrane. Suitable materials that can be used for the separator 109 include, but are not limited to, polymers such as polypropylene, polyethylene and composites of them, as well as PTFE. The separator membrane is permeable to lithium ions, allowing them to travel from the cathode side to the anode side and back during the charge-discharge cycle. But the separator membrane is impermeable to anode and cathode materials, preventing them from mixing, touching, and shorting the battery. The separator membrane can also serve as an electrical insulator for metal parts of the battery (leads, tabs, metal parts of the enclosure, etc.) preventing them from touching and shorting. The separator membrane can also prevent flow of the electrolyte.

In some aspects, the separator 109 is a thin (about 15-25 μm) polymer membrane (tri-layer composite: polypropylene-polyethylene-polypropylene, commercially available) between two relatively thick (about 20-1000 μm) porous electrode sheets. The thin polymer membrane may be about 15-25 μm thick, such as 15-23, 15-21, 15-20, 15-18, 15-16, 16-25, 16-23, 16-21, 16-20, 16-18, 18-25, 18-23, 18-21, 18-20, 20-25, 20-23, 20-21, 21-25, 21-23, 23-25, 15, 16, 17, 18, 19, 20, 21, 22, 23, 24, or 25 μm thick, or any integer or subrange in between. The two relatively thick porous electrode sheets may each independently be 50-500 μm thick, such as 50-450 μm, 50-400 μm, 50-350 μm, 50-300 μm, 50-250 μm, 50-200 μm, 50-150 μm, 50-100 μm, 50-75 μm, 50-60 μm, 50-55 μm, 55-500 μm, 55-450 μm, 55-400 μm, 55-350 μm, 55-300 μm, 55-250 μm, 55-200 μm, 55-150 μm, 55-100 μm, 55-75 μm, 55-60 μm, 60-500 μm, 60-450 μm, 60-400 μm, 60-350 μm, 60-300 μm, 60-250 μm, 60-200 μm, 60-150 μm, 60-100 μm, 60-75 μm, 75-500 μm, 75-450 μm, 75-400 μm, 75-350 μm, 75-300 μm, 75-250 μm, 75-200 μm, 75-150 μm, 75-100 μm, 100-500 μm, 100-450 μm, 100-400 μm, 100-350 μm, 100-300 μm, 100-250 μm, 100-200 μm, 100-150 μm, 150-500 μm, 150-450 μm, 150-400 μm, 150-350 μm, 150-300 μm, 150-250 μm, 150-200 μm, 200-500 μm, 200-450 μm, 200-400 μm, 200-350 μm, 200-300 μm, 200-250 μm, 250-500 μm, 250-450 μm, 250-400 μm, 250-350 μm, 250-300 μm, 300-500 μm, 300-450 μm, 300-400 μm, 300-350 μm, 350-500 μm, 350-450 μm, 350-400 μm, 400-500 μm, 400-450 μm, 450-500 μm, 50 μm, 55 μm, 60 μm, 75 μm, 100 μm, 150 μm, 200 μm, 250 μm, 300 μm, 350 μm, 400 μm, 450 μm, or 500 μm, or any integer or subrange in between.

The electrolyte 107 can be a liquid electrolyte, a gel electrolyte, or a combination thereof. The electrolyte 107 can include one or more polymers and/or lithium based materials. Illustrative, but non-limiting, examples of electrolytes and components of electrolytes include poly(ethylene oxide) (PEO), poly(propylene oxide)(PPO), poly(vinyl alcohol) (PVA), poly(vinylidene fluoride) (PVDF), poly(acrylonitrile) (PAN), poly(vinyl chloride) (PVC), poly(methyl methacrylate) (PMMA), hexafluoropropylene (HFP), and poly(ethyl α-cyanoacrylate) (PECA); monomers or polymers of ethylene carbonate (EC), propylene carbonate, dimethyl carbonate (DMC), diethylcarbonate (DEC), dimethylformamide (DMF), dimethylsulfoxide (DMSO), butyrolactone (BL), gamma-butyrolactone (γ-BL), and 2-methyl-2-oxazoline; and lithium-based materials such as LiClO₄, LiCF₃SO₃, LiBF₄, and LiN(CF₃SO₂)₂. Combinations of the aforementioned materials, as well as copolymers of the aforementioned materials, can be used. Examples of polymer gel electrolytes that can be used include PAN-EC/PC/DMF-LiClO₄, PMMA-EC/PC-LiClO₄, PAN-EC/PC-LiClO₄, PVC-EC/PC-LiClO₄, PAN-EC/PC-LiCF₃SO₃, PAN-EC/DEC-LiClO₄, PVDF-EC/PC-LiBF₄, PVDF-HFP-EC/DEC-LiN(CF₃SO₂)₂, PMMA-EC/PC/γ-BL-LiCF₃SO₃, and PMMA-EC/DMC-LiN(CF₃SO₂)₂.

The present disclosure also generally relates to processes for monitoring the structural health (e.g., damage) of an energy storage device and/or a component thereof, e.g., an electrode. As described above, the controller 130 can be coupled permanently to the energy storage device to enable real-time and/or operando monitoring, and/or the controller 130 can be coupled periodically to the energy storage device, such as, in instances where scheduled maintenance can be performed.

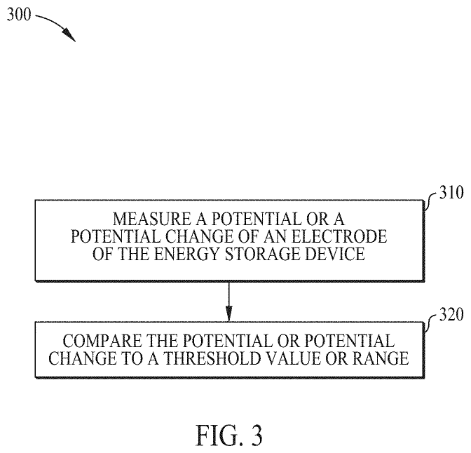

FIG. 3 is a flowchart showing selected operations of a process 300 for monitoring the structural health (e.g., damage) of an energy storage device and/or an electrode thereof. In some examples, a characteristic of the electrode and/or the energy storage device, such as a potential, a potential change, a voltage, a voltage change, a current, a current change, a resistance, and/or a resistance change, can be measured, monitored, determined, or otherwise detected.

For potential and potential change measurements, a change in potential such as a potential drop, can be measured, monitored, determined, or otherwise detected. To begin, a potential is established between the anode 105 and the cathode 101 as a battery, e.g., between contacts 111 and 117. At operation 310, a potential or potential change is then measured along the anode 105 and the cathode 101, e.g., between contacts 111 and 113, and contacts 115 and 117 respectively, via the controller 130. At operation 320, the potential or potential change V is compared to a threshold value of the characteristic (e.g., Vₜₕ). The threshold value Vₜₕ can be a specific value or a range of values determined based on normal operation data of a battery. Normal operation data can be reference data collected for normal (or proper) battery operation. In some aspects, and when a flexible electrode is utilized, the normal operation data can include normal bending, stretching, and/or twisting. The threshold value Vₜₕ can be a data set stored on a memory device, such as the memory 134. The threshold value Vₜₕ can correspond to a state of structural health of the battery 150.

The change in potential is a result of, e.g., resistance changes due to the structural changes of the battery 150, and the resistance changes as a result of the piezoresistance effect. To determine if the measured potential or potential change is indicative of damage to an electrode of the battery 150, the measured potential or potential change can be compared to the threshold potential value or range, or threshold potential change value or range, respectively. Damage to the electrode can be indicated when the detected potential (or potential change) passes, exceeds, falls below, or falls outside of, a threshold potential (or potential change) value or threshold potential (or potential change) range.

As a non-limiting example, if the measured potential or potential change (Vₘ) is determined to be less than the threshold value Vₜₕ (indicating that the battery is operating normally), operation of the battery 150 can be continued. Here, the controller 130 can send a signal to an input/output device, such as a display unit or an audio device indicating that the battery 150 can be utilized. If the measured potential or potential change Vₘ of the battery 150 is determined to be greater than or equal to the threshold value (Vₘ≥Vₜₕ), the controller 130 sends a warning to an input/output device, such as a display unit or an audio device. The warning indicates that an action is to be performed on the battery. Operations 310 and 320 can be repeated for a predetermined time period or for a predetermined number of determination cycles, e.g., second, third, or nth iterations.

An example of the action performed of operation 320 can include shutting off an article 151 that uses the battery 150. For example, the article 151 can be caused to stop receiving power from the battery 150. Another example of the action performed of operation 320 can include removing the battery 150 from use. Here, this action can further include replacing the battery 150 with a different battery such that Vₘ of the new battery becomes less than the threshold value Vₜₕ. The potential or potential change of the new battery can be determined at a new time iteration. The process 300 can repeat for a predetermined time period or for a predetermined number of determination cycles.

As another example of an action performed at operation 320, and after the article 151 has been caused to stop receiving power from the battery 150, the article 151 can be caused to receive power from the battery in order to re-check (or validate) the measurement. Other illustrative, but non-limiting, examples of the action performed of operation 320 can include performing maintenance on the energy storage device (e.g., battery 150) and/or electrode, inspecting the energy storage device and/or electrode, ordering an energy storage device, electrode, and/or a component thereof, replacing the energy storage device, electrode, and/or portion thereof. Additionally, or alternatively, the example process 300 can include a system that incorporates a contacting system to, e.g., contact a user, a driver, a maintenance office, and the like, that an inspection is needed on the energy storage device and/or the electrode. One or more of these illustrative actions, and others, can be performed at operation 320.

In some embodiments, one or more operations of the device 100 and/or one or more operations of process 300 described herein can be implemented using a programmable logic controller (PLC) and/or can be included as instructions in a computer-readable medium for execution by a control unit (e.g., controller 130 and/or the at least one processor 132) or any other processing system. The computer-readable medium can include any suitable memory for storing instructions, such as read-only memory (ROM), random access memory (RAM), flash memory, an electrically erasable programmable ROM (EEPROM), a compact disc ROM (CD-ROM), a floppy disk, punched cards, magnetic tape, and the like.

The energy storage devices and the processes described herein can enable automatic, continuous (and/or periodic) monitoring of the structural health of energy storage devices and electrodes. Any damage can be detected in order to ensure the structural integrity of the energy storage device, electrode, or other component. The energy storage devices with structural health monitoring described herein are suitable for integration in an existing production process for an energy storage device and enables self-diagnosis. In addition, the energy storage devices and processes described herein can enable detection of damage that can be hidden under a surface of the energy storage device.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (e.g. amounts, dimensions, etc.) but some experimental errors and deviations should be accounted for.

### Example 1: Example Self Standing Electrode

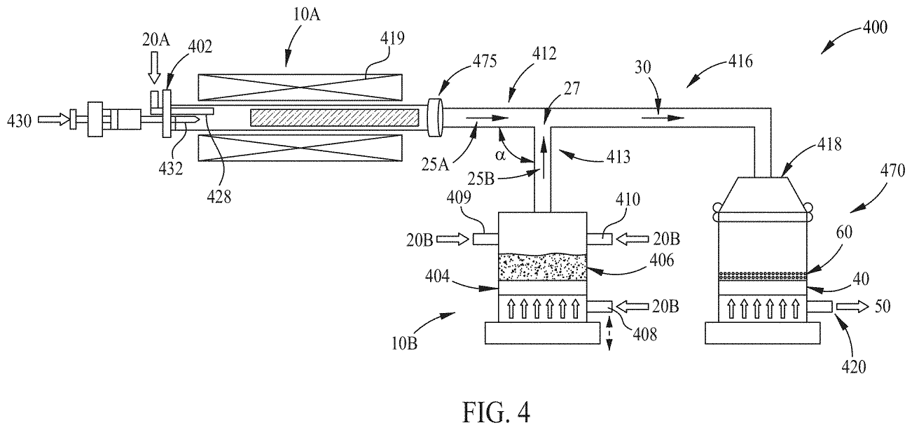

An example self-standing electrode was produced according to U.S. Pat. No. 10,658,651, which is incorporated herein by reference in its entirety. A quartz tube having dimensions of 25 mm OD×22 mm ID×760 mm length was used as the carbon nanotube reactor 10A for the apparatus 400 (FIG. 4). The carbon nanotube reactor 10A was aligned horizontally with a left end closed with a barrier 402. However, the carbon nanotube reactor 10A could be aligned vertically or at any angle (α) therebetween. At the center of barrier 402, a carrier gas inlet 428 was provided for the carrier gas 20A and a catalyst/catalyst precursor inlet 432 was provided for the catalyst/catalyst precursor 430. Both the carrier gas inlet 428 and the catalyst/catalyst precursor inlet 432 were positioned to the left of the section of the carbon nanotube reactor 10A heated by the heat source 419.

The carbon nanotube reactor 10A was heated to a temperature of about 1300° C. The carrier gas 20A included a mixture of about 850 sccm argon (Ar) and about 300 sccm H₂ and was provided to the carbon nanotube reactor 10A via the carrier gas inlet 428. The catalyst/catalyst precursor 430 composition was ˜80% ethanol, ˜20% methanol, ˜0.18% ferrocene, and ˜0.375% thiophene. The ethanol functioned both as a solvent for the ferrocene and as the carbon source for growing the nanotubes. The catalyst/catalyst precursor 430 solution was injected at a rate of about 0.3 mL/min via the catalyst/catalyst precursor inlet 432 into the reactor carbon nanotube growth zone, where the ferrocene decomposed to iron catalyst particles and the ethanol was converted to a carbon source for the growth of single-walled nanotubes on the iron catalysts. The carrier gas 20A transported the single-walled nanotubes through reactor outlet 475 and into tube 412 as the first aerosolized stream 25A.

Lithium nickel manganese cobalt oxide (LiNiMnCoO₂) particles were used as the electrode active material 406 and were loaded into aerosolizing chamber 10B on a porous frit 407 to a height of about 5 mm, loading about 50 g. The carrier/aerosolizing gas 20B, Ar, was provided at a rate of about 2 L/min Ar through the porous fit 407 via inlet 408 (˜1 L/min; bottom up) and inlets 409, 410 (˜1 L/min; tangential flows) in combination. Aerosolized suspended LiNiMnCoO₂ exits aerosolizing chamber 10B as the second aerosolized stream 25B via tube 413 and combines with the first aerosolized stream 25A comprising the synthesized carbon nanotubes traveling through tube 412 at the junction 27, forming a mixture 30 of aerosolized, suspended LiNiMnCoO₂ and carbon nanotubes in the carrier gases. The mixture 30 travels through tube 416 into collection chamber 470 via an inlet 418. The mixture 30 of LiNiMnCoO₂ and carbon nanotubes deposits on the porous substrate 40, in this case a porous frit, as a composite self-standing electrode 60, as the carrier gases 50 pass through the porous substrate 40 and out an exhaust 420.

Two composite self-standing electrodes 60 were collected from the porous substrate that included about 0.8 wt % single-walled carbon nanotubes and the balance LiNiMnCoO₂ particles. The self-standing electrode was then treated to increase the density by pressing (7 ton), to afford a treated self-standing electrode. The composite self-standing electrodes 60 are flexible and allow for bending. The composite self-standing electrodes are characterized as having a carbon nanotube web surrounding the LiNiMnCoO₂ particles to retain the LiNiMnCoO₂ particles therein without the use of a binder or current collector foils.

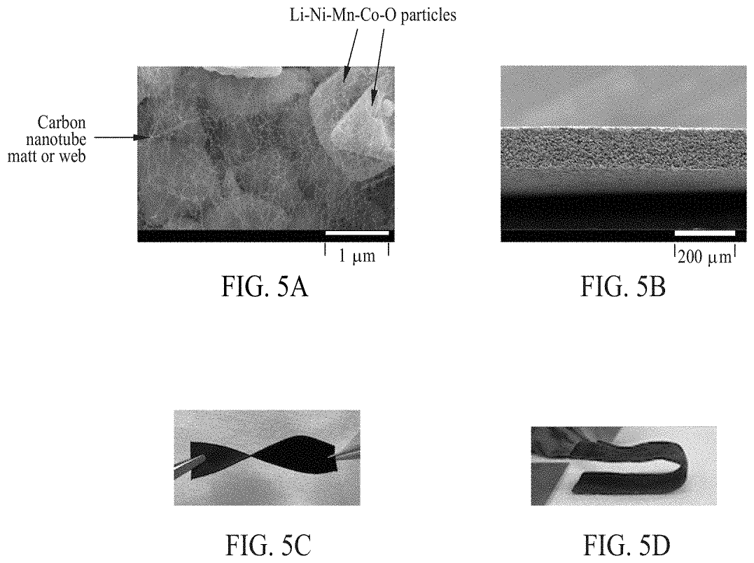

FIGS. 5A and 5B show SEM images of the resulting nanotubes and composite material formed in Example 1. The results indicate that the method provides very homogeneous dispersion of pristine carbon nanotubes throughout the composite material, where the active material particles (LiNiMnCoO₂) are embedded in the homogeneous three-dimensional cross-linked fine single-walled nanotube network. FIGS. 5C and 5D are exemplary photographs of the self-standing electrodes illustrating their flexibility and stretchability.

### Example 2: Electrochemical Performance and Operando Monitoring

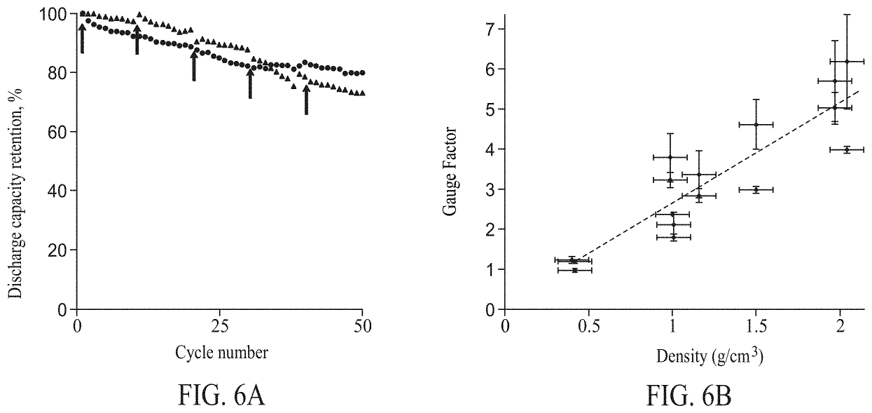

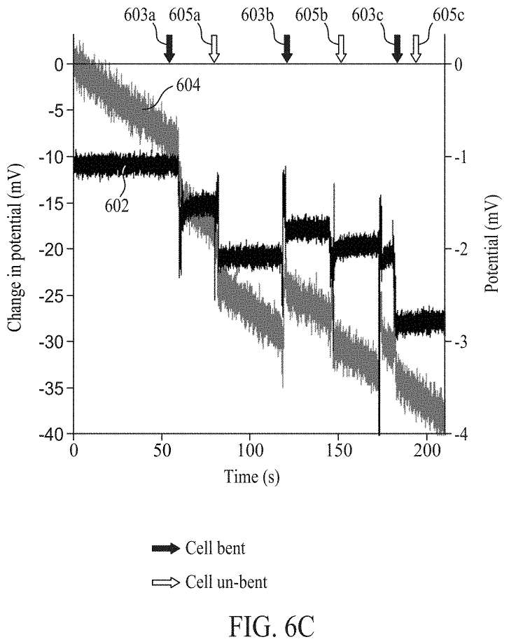

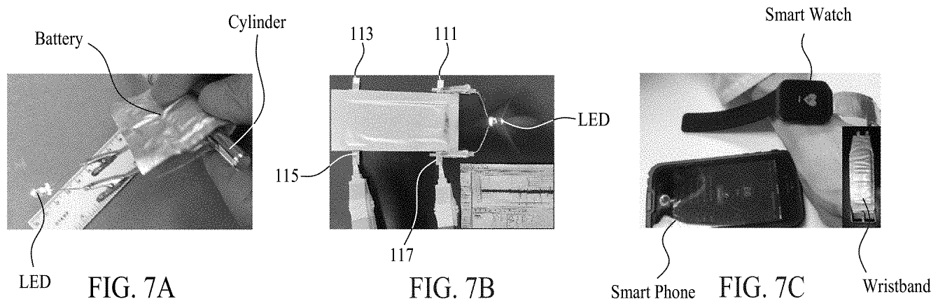

A flexible battery, fabricated from the electrodes of Example 1, was subjected to various electrochemical investigations. FIGS. 6A-6C show data from the electrochemical measurements and FIGS. 7A and 7B show exemplary images of the flexible battery during the certain electrochemical measurements.

Specifically, FIG. 6A shows exemplary data for the normalized discharge capacity of a flexible battery fabricated with the current collector-free self-standing cathodes and anodes made according to Example 1. The flexible battery was subjected to cycling while bending down to a 7 mm diameter with 0.2 C charge/discharge rates. FIG. 7A shows the flexible battery being bent around a 1 inch diameter cylinder while powering the LED. In FIG. 6A, the triangles correspond to the performance when the cell was subjected to mechanical stress every 10 cycles, while the circles correspond to the undisturbed performance evaluation. The arrows indicate the cycles when the cell was subjected to mechanical stresses (10 wraps around a 1 inch diameter cylinder in one direction and then in the opposite direction). The performance between the flexible battery under mechanical stress was determined to be almost identical to that of a similar battery without mechanical stress applied to it. FIG. 6A thus demonstrates the capacity retention of the battery depending on the cycling numbers showing that if the battery is healthy, the battery under typical use and under are identical or nearly identical.

FIG. 6B shows exemplary data for the gauge factor dependence on the electrode density. The gauge factor (GF) or strain factor of a strain gauge is the ratio of relative change in electrical resistance to the mechanical strain. GF is defined in Equation 1 as:

GF=(ΔR/R)/(ΔL/L)=(ΔR/R)/ε

where ΔR is the change in resistance due to strain; R is the initial resistance; ε=mechanical strain=ΔL/L, where ΔL is the absolute change in length of the electrode, and L is the original length of the electrode.

The GF dependence on electrode density was calculated from relative changes in resistance (R/R₀) versus strain curves of self-standing cathode sheets that contain about 1 wt % single-walled carbon nanotubes (data not shown). In this case, the GF is a measure of the sensitivity of the nanotube network to the strain developing in the cathode sheet and is given by the formula shown in Equation 1.

Depending on the electrode density, the gauge factor was determined to be from about from 1.1 to 5.12 for densities variation from 0.42 to 2.0 g/cm³, as shown in FIG. 6B. With relatively low densities, the GF increases in a substantially linear manner, yet at higher density, the growth of GF is slower. The data indicates that the method allows detecting resistance changes due to the structural changes in the electrode sheets and thereby is capable to predict battery failure in advance because of structural defects.

FIG. 6C shows exemplary data for real-time, operando monitoring/measurement of the variation of the potential along the cathode (curve 602) and corresponding battery potential variation (curve 604), when the flexible battery was subjected to repeated mechanical stress (bending) with and without a 10 mA load. The load used was a light-emitting diode (LED). The contacts on each electrode allow autonomous measurement of the potential through each electrode. In FIG. 6C, curve 604 shows when the battery is vulnerable to mechanical impacts, e.g., spikes during bending, that can influence battery performance. Curve 602 indicates that the apparatus provided herein can detect these changes in the battery performance with the corresponding spikes in the curve 602.

FIG. 7B is an exemplary photograph during the real-time, operando monitoring/measurement of the variation of the potential across the cathode (FIG. 6C) while the flexible battery powers an LED. An article 151 (an LED shown in FIG. 7B) is powered by an anode contact (e.g., first anode contact 111) and a cathode contact (e.g., first cathode contact 117). Contacts 115 and 117 of the cathode are utilized for potential measurements along the cathode as shown by curve 602 in FIG. 6C.

The measured potential or potential changes for the cathode (curve 602) during battery bending at time points 603a, 603b, and 603c and during battery unbending at time points 605a, 605b, and 605c are shown in FIG. 6C. The corresponding changes of the battery potential variation (curve 604) are also shown. The data indicates that potential or potential changes (curve 602), which are a result of battery malfunctioning (curve 604), can be detected.

Brunauer-Emmet-Teller investigations (not shown) revealed that the applied load during the bending of the flexible battery led to a pore size redistribution in the cathode. These results further confirm that damage formation, cracks, void accumulations, etc., can be detected during use of the flexible battery. As such, the nanotube network of the electrode not only replace the current collectors, binders, and additives, but can also serve as a sensor for operando self-monitoring of battery health.

To demonstrate the feasibility of the battery architecture in practice, a flexible battery was shaped as a wristband (image in the inset), and was used to power a commercial smart watch (FIG. 7C). The commercial smart watch was originally manufactured with a power source of 3.7 V and 250 mAh and the smart watch featured a heart-rate monitoring sensor which can transfer data to a cellular telephone via Bluetooth. The flexible battery can be charged by the USB charger of the smart watch. As shown in FIG. 7C, the flexible battery can successfully start and run the smart watch, operate the heart-rate monitoring sensor, and transfer data to the smart phone.

The apparatus and processes described herein can provide non-destructive, real-time monitoring of energy storage devices, and be low cost, especially when measured against costs associated with the failure of electrodes and battery storage devices. Moreover, the diagnostic information provided by apparatus and processes described herein can, e.g., help engineers design an improved version of the electrodes and battery storage devices. In some aspects, the lack of, e.g., current collector metal foils of the flexible battery and the piezoresistance ability of the electrodes can enable real-time, operando monitoring of changes of electrodes' mechanical properties and the corresponding battery health. Currently there are no established prognostic methods for batteries to diagnose the degradation processes and determine the health of lithium-ion batteries in operando and in the field. The ability to monitor the structural health of energy storage devices continuously, and during operation, as enabled by embodiments described herein, would not only improve the safety of the energy storage devices, but would also provide information on how to manufacture structurally durable energy storage devices and components thereof.

### Aspects Listing

The present disclosure provides, among others, the following aspects, each of which can be considered as optionally including any alternate aspects:

Clause 1. An apparatus, comprising:
an energy storage device comprising an electrode, the electrode comprising a nanotube network and an active material, the active material comprising:
   LiFePO₄, LiCoO₂, Li—Ni—Mn—Co—O, or combinations thereof, when the electrode is a cathode; or
   Si, SiOx/C, graphite, or combinations thereof, when the electrode is an anode; and
a processor configured to determine a first value of potential change of the electrode of the energy storage device and to compare the first value of potential change to a threshold value or range.

Clause 2. The apparatus of Clause 1, wherein the nanotube network stresses, strains, bends, or otherwise deforms in response to damage of the electrode.

Clause 3. The apparatus of Clause 1 or Clause 2, wherein a concentration of the nanotube network in the electrode is from about 0.5 wt % to about 10 wt %.

Clause 4. The apparatus of any one of Clauses 1-3, wherein the electrode is a cathode, the cathode further comprising lithium.

Clause 5. The apparatus of any one of Clauses 1-4, further comprising an article electrically coupled to the energy storage device, the article being a component of a land vehicle, an aircraft, a watercraft, a spacecraft, a satellite, a light emitting diode, a consumer electronic, a wind turbine, a building, a bridge, or a pipeline.

Clause 6. The apparatus of Clause 5, wherein the processor is further configured to cause the component to stop receiving power from the energy storage device when the first value of potential change is equal to or greater than the threshold value or range.

Clause 7. The apparatus of any one of Clauses 1-6, wherein, when the first value of potential change is determined to be less than the threshold value or range, the processor is further configured to:
determine a second value of potential change; and
compare the second value of potential change to the threshold value or range.

Clause 8. The apparatus of any one of Clauses 1-7, wherein the energy storage device is a flexible battery.

Clause 9. A process for monitoring structural health of an energy storage device, comprising:
determining a first value of potential change of an electrode of the energy storage device, the electrode having a nanotube network and an active material embedded therein, the active material comprising:
   LiFePO₄, LiCoO₂, Li—Ni—Mn—Co—O, or combinations thereof, when the electrode is a cathode; or
   Si, SiOx/C, graphite, or combinations thereof, when the electrode is an anode; and
comparing the first value of potential change to a threshold value or range.

Clause 10. The process of Clause 9, wherein the first value of potential change indicates damage to the electrode when the first value of potential change is equal to or greater than the threshold value or range.

Clause 11. The process of Clause 9 or Clause 10, wherein, when the first value of potential change is equal to or greater than the threshold value or range, the process further comprises one or more of performing maintenance on the energy storage device, inspecting the energy storage device, ordering a different energy storage device, or replacing the energy storage device.

Clause 12. The process of any one of Clauses 9-11, further comprising stopping use of the energy storage device when the first value of potential change is equal to or greater than the threshold value or range.

Clause 13. The process of Clause 12, further comprising resuming use of the energy storage device after stopping use of the energy storage device to determine another value of potential change.

Clause 14. The process of any one of Clauses 9-13, wherein, when the first value of potential change is determined to be less than the threshold value or range, the process further comprises:
determining a second value of potential change; and
comparing the second value of potential change to the threshold value or range.

Clause 15. The process of any one of Clauses 9-14, wherein the energy storage device is a flexible lithium ion battery.

Clause 16. A non-transitory computer-readable medium storing instructions that, when executed on a processor, perform operations for monitoring structural health of a lithium ion battery, the operations comprising:
determining a first value of potential change of an electrode of the lithium ion battery, the electrode having a nanotube network and an active material embedded therein, the active material comprising:
   LiFePO₄, LiCoO₂, Li—Ni—Mn—Co—O, or combinations thereof, when the electrode is a cathode; or
   Si, SiOx/C, graphite, or combinations thereof, when the electrode is an anode; and
comparing the first value of potential change to a threshold value or range.

Clause 17. The non-transitory computer-readable medium of claim 16, wherein the lithium ion battery is a flexible lithium ion battery.

Clause 18. The non-transitory computer-readable medium of claim 16, further comprising an article electrically coupled to the lithium ion battery, the article being a component of a land vehicle, an aircraft, a watercraft, a spacecraft, a satellite, a consumer electronic, a wind turbine, a building, a bridge, or a pipeline.

Clause 19. The non-transitory computer-readable medium of Clause 18, wherein the operations further comprise:
causing the article to stop receiving power from the lithium ion battery when the first value of potential change is equal to or greater than the threshold value or range;
causing the article to continue receiving power from the lithium ion battery to determine another value of potential change; or
a combination thereof.

Clause 20. The non-transitory computer-readable medium of any one of Clauses 16-19, wherein, when the first value of potential change is less than the threshold value or range, the operations further comprise:
determining a second value of potential change; and
comparing the second value of potential change to the threshold value or range.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “an electrode” include aspects comprising one, two, or more electrodes, unless specified to the contrary or the context clearly indicates only one electrode is included.

Various aspects of the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other circuit elements that are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software module(s) stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Additionally, or alternatively, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

While the foregoing is directed to aspects of the present disclosure, other and further aspects of the disclosure may be devised without departing from the basic scope thereof, and the scope thereof is determined by the claims that follow.

What is claimed is:

1. An apparatus, comprising:
an energy storage device comprising an electrode, the electrode comprising a nanotube network and an active material, the active material comprising:
LiFePO₄, LiCoO₂, Li—Ni—Mn—Co—O, or combinations thereof, when the electrode is a cathode; or
Si, SiOx/C, graphite, or combinations thereof, when the electrode is an anode; and
a processor configured to determine a first value of potential change of the electrode of the energy storage device and to compare the first value of potential change to a threshold value or range.

2. The apparatus of claim 1, wherein the nanotube network stresses, strains, bends, or otherwise deforms in response to damage of the electrode.

3. The apparatus of claim 1, wherein a concentration of the nanotube network in the electrode is from about 0.5 wt % to about 10 wt %.

4. The apparatus of claim 1, wherein the electrode is a cathode, the cathode further comprising lithium.

5. The apparatus of claim 1, further comprising an article electrically coupled to the energy storage device, the article being a component of a land vehicle, an aircraft, a watercraft, a spacecraft, a satellite, a light emitting diode, a consumer electronic, a wind turbine, a building, a bridge, or a pipeline.

6. The apparatus of claim 5, wherein the processor is further configured to cause the component to stop receiving power from the energy storage device when the first value of potential change is equal to or greater than the threshold value or range.

7. The apparatus of claim 1, wherein, when the first value of potential change is determined to be less than the threshold value or range, the processor is further configured to:
determine a second value of potential change; and
compare the second value of potential change to the threshold value or range.

8. The apparatus of claim 1, wherein the energy storage device is a flexible battery.

9. A process for monitoring structural health of an energy storage device, comprising:
determining a first value of potential change of an electrode of the energy storage device, the electrode having a nanotube network and an active material embedded therein, the active material comprising:
LiFePO₄, LiCoO₂, Li—Ni—Mn—Co—O, or combinations thereof, when the electrode is a cathode; or
Si, SiOx/C, graphite, or combinations thereof, when the electrode is an anode; and
comparing the first value of potential change to a threshold value or range.

10. The process of claim 9, wherein the first value of potential change indicates damage to the electrode when the first value of potential change is equal to or greater than the threshold value or range.

11. The process of claim 9, wherein, when the first value of potential change is equal to or greater than the threshold value or range, the process further comprises one or more of performing maintenance on the energy storage device, inspecting the energy storage device, ordering a different energy storage device, or replacing the energy storage device.

12. The process of claim 9, further comprising stopping use of the energy storage device when the first value of potential change is equal to or greater than the threshold value or range.

13. The process of claim 12, further comprising resuming use of the energy storage device after stopping use of the energy storage device to determine another value of potential change.

14. The process of claim 9, wherein, when the first value of potential change is determined to be less than the threshold value or range, the process further comprises:
determining a second value of potential change; and
comparing the second value of potential change to the threshold value or range.

15. The process of claim 9, wherein the energy storage device is a flexible lithium ion battery.

16. A non-transitory computer-readable medium storing instructions that, when executed on a processor, perform operations for monitoring structural health of a lithium ion battery, the operations comprising:
determining a first value of potential change of an electrode of the lithium ion battery, the electrode having a nanotube network and an active material embedded therein, the active material comprising:
LiFePO₄, LiCoO₂, Li—Ni—Mn—Co—O, or combinations thereof, when the electrode is a cathode; or
Si, SiOx/C, graphite, or combinations thereof, when the electrode is an anode; and
comparing the first value of potential change to a threshold value or range.

17. The non-transitory computer-readable medium of claim 16, wherein the lithium ion battery is a flexible lithium ion battery.

18. The non-transitory computer-readable medium of claim 16, further comprising an article electrically coupled to the lithium ion battery, the article being a component of a land vehicle, an aircraft, a watercraft, a spacecraft, a satellite, a consumer electronic, a wind turbine, a building, a bridge, or a pipeline.

19. The non-transitory computer-readable medium of claim 18, wherein the operations further comprise:
causing the article to stop receiving power from the lithium ion battery when the first value of potential change is equal to or greater than the threshold value or range;
causing the article to continue receiving power from the lithium ion battery to determine another value of potential change; or
a combination thereof.

20. The non-transitory computer-readable medium of claim 16, wherein, when the first value of potential change is less than the threshold value or range, the operations further comprise:
determining a second value of potential change; and
comparing the second value of potential change to the threshold value or range.
